(19) United States
(12) Patent Application Publication
(10) Pub. No.: US 2010/0114874 A1
(43) Pub. Date: May 6, 2010

(54) PROVIDING SEARCH RESULTS

(75) Inventors: Othar Hansson, Sunnyvale, CA (US); Ramananthan V. Guha, Los Altos, CA (US); Walton W. Lin, New York, NY (US); Nicholas B. Weininger, San Francisco, CA (US); Paul Haahr, San Franciso, CA (US); Kavi J. Goel, Mountain View, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/254,598

(22) Filed: Oct. 20, 2008

(51) Int. Cl. G06F 17/30

(52) U.S. Cl. 707/722; 707/E17.108

(57) ABSTRACT

Methods, systems, and apparatus, including computer program products, for responding to a search query received from a user. From a web page a search result display object and template are identified. The search result display object specifies content available for display in a search result, and the template renders at least some of the content in the search result. The search result is presented responsive to a search query received from a user, where the search result is associated with the web page containing the search result display object and template.

### BACKGROUND

This specification relates to providing search results in response to a search query.

The World Wide Web (“web”) contains a vast amount of information. Locating a desired portion of the information, however, can be challenging. This problem is compounded because the amount of information on the web and the number of new users inexperienced at web searching are growing rapidly.

Search engine systems attempt to return hyperlinks to web pages in which a user is interested. Generally, search engine systems base their determination of the user's interest on the one or more search terms in a search query entered by the user. One goal of a search engine system is to provide links to high quality, relevant resources, such as web pages, to the user based on the search query. Conceptually, the search engine system accomplishes this by matching the terms in the search query to contents of pre-stored web pages or other resources. Web pages that contain the user's search terms are “hits” and links to those web pages are returned to the user as part of the search results.

When an existing search engine system returns search results, the search results often include links to web pages from various web sites. The user can then select one of the links to a particular web page to attempt to find the item of interest.

### SUMMARY

Conventional search engine systems provide search results in an order, but do not provide information in the search results that is selected by a web page provider as information the web page provider wishes to be listed in the search results.

Thus, in general, one aspect of the subject matter described in this specification can be embodied in methods that include the actions of identifying, from a web page a search result display object, the search result display object specifying content available for display in a search result, and a template that renders at least some of the content in the search result. The methods also include the actions of presenting the search result responsive to a search query received from a user, wherein the search result is associated with the web page containing the search result display object and template.

These and other embodiments can optionally include one or more of the following features. The search result display object and/or template can be retrieved from the web page. Identifying the template can include identifying a template file. The template can be used to identify the at least some of the content that is displayed. The template can also or alternatively be used to determine the display location and/or size of the at least some of the content presented in the search result. One or more default templates may be selected, e.g., by webmasters, to display content identified by the webmaster using search result display objects.

The following optional features can also be included. The web page is crawled to identify the search result display object before a search query is received. A search result display object is created based on information retrieved from the web page during a crawling of the web page. A second search result is displayed in a different format than the search result. Both the search result and a second search result can be displayed on the same search results web page.

Particular embodiments of the subject matter described in this specification can be implemented so as to realize one or more of the following advantages. Search results responsive to a user query provide a user with customized textual and/or graphical information that is useful to the user. At least a portion of the textual and/or graphical information is selected by a webmaster as information the web page provider wishes to be listed in the search results. Additionally, at least a portion of the textual and/or graphical information can be presented to the user in a format selected by the webmaster using one or more templates, to enable the webmaster to distinguish the web page from other search results and to provide the user with useful information regarding the web page, thereby increasing the likelihood that a user will select the customized search result. Additionally, templates may be auto-selected based on the types of objects found on the page during crawling of the web page so that webmasters do not have to design their own templates.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example search system according to an illustrative implementation.

FIG. 2 illustrates an implementation of a storage system.

FIG. 3 is a functional block diagram illustrating an example search engine server in a search system.

FIG. 4 shows an example search result display object that includes sets of key-value pairs.

FIG. 5 shows an example template and search result display object contained within a web page.

FIG. 6 illustrates an example search results web page.

FIG. 7 is a flow diagram for an example method implemented by a search system.

FIG. 8 is a flow diagram illustrating a method as performed by a webmaster and a search system.

Like reference numbers and designations in the various drawings indicate like elements.

### DETAILED DESCRIPTION

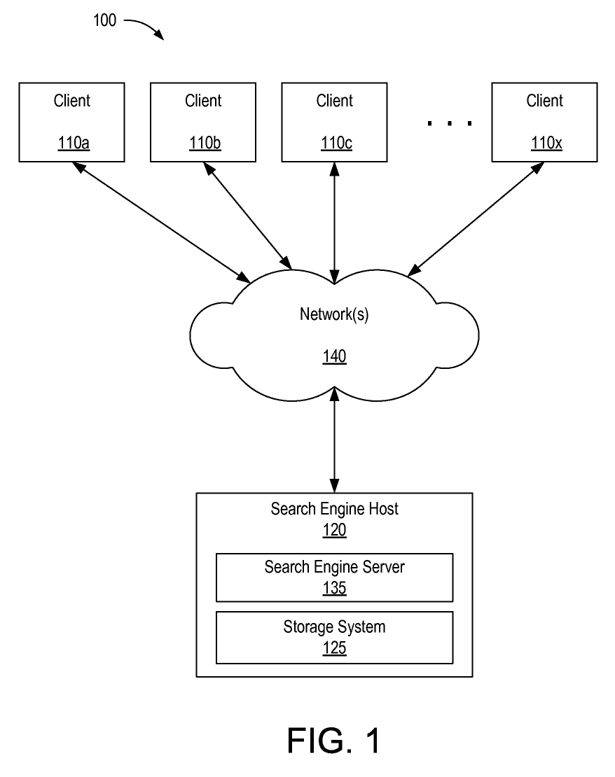

FIG. 1 illustrates an example search system 100 according to an illustrative implementation. The system 100 includes clients 110a, 110b, 110c, . . . 110x in communication with a search engine host 120 over one or more networks 140. Although multiple clients 110a, 110b, 110c, . . . 110x and a single host 120 are illustrated in FIG. 1, there can be more servers and more or fewer clients. For instance, some of the functions performed by the host 120 can be performed by one or more other servers such that the host 120 can be implemented as several devices, such as a network of computer processors and/or servers.

The clients 110a, 110b, 110c, . . . 110x can be a hardware device, such as a personal computer, a wireless telephone, a personal digital assistant (PDA), a laptop computer, or another type of computation or communication device, a thread or process executed by a hardware device, and/or an object executed by one of these devices. The host 120 can include one or more servers that gather, process, maintain, or manage information and/or provide search results to users.

In some implementations, the host 120 includes a storage system 125 that processes and stores information associated with, for example, web page accesses, such as click-related information, associated with the clients' 110a, 110b, 110c, . . . 110x access of web pages. Although illustrated within the host 120, the storage system 125 can be external to and/or separate from the host 120 and can communicate with the host 120 through the one or more network(s). The storage system 125 can also store data embedded in web pages that enables custom display of search results as defined by web page providers. This data can include search result display objects identifying key-value pairs, one or more template files (or references thereto), and/or one or more user-defined templates. The data stored by the storage system 125 is used by the host 120 to display query search results to users.

The host 120 can also include a search engine server 135 usable by the clients 110a, 110b, 110c, . . . 110x. The search engine server 135 can receive search queries from clients 110 and return relevant information to clients 110a, 110b, 110c, . . . 110x.

The network(s) 140 can include one or more local area networks (LANs), wide area networks (WANs), telephone networks, such as the Public Switched Telephone Network (PSTN), intranets, the Internet, and/or or other type of network. The clients 110a, 110b, 110c, . . . 110x and host 120 can connect to the network(s) 140 via wired, wireless, or optical or other connections. In alternative implementations, one or more of the devices illustrated in FIG. 1 are directly connected to another one of the devices. For example, in one implementation, the clients 110a, 110b, 110c, . . . 110x are directly connected to the host 120.

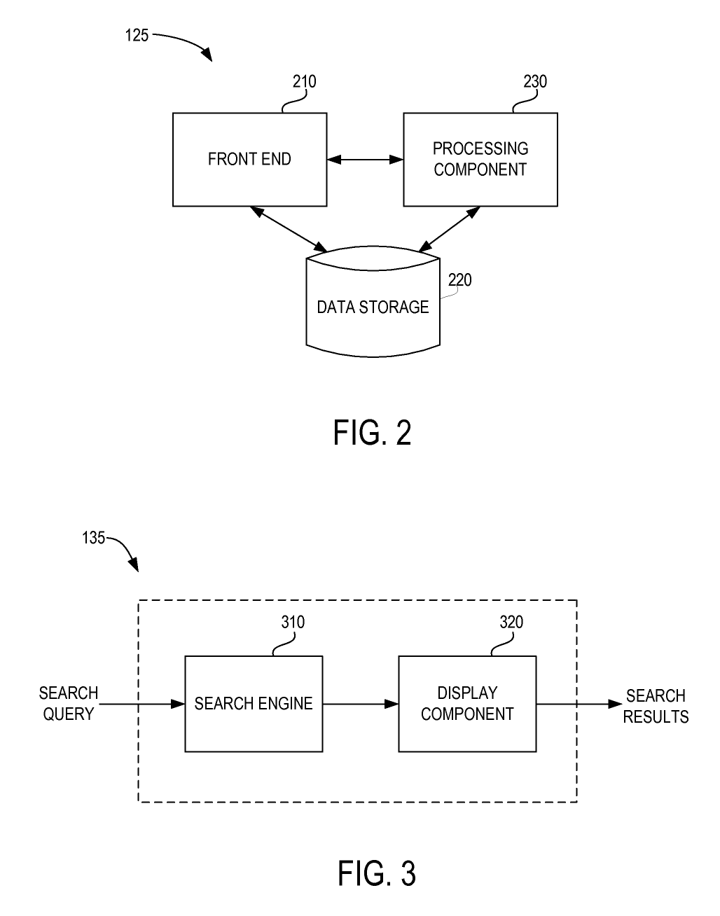

FIG. 2 illustrates an implementation of a storage system 125. The storage system 125 can include a front end 210, a data storage 220, and a processing component 230. The front end 210 receives information associated with clients' 110a, 110b, 110c, 110x access of various web pages/sites. For example, the front end 210 can receive hypertext transfer protocol (HTTP) requests when a client 110a, 110b, 110c, . . . 110x accesses a web page. The front end 210 can transmit this information for storage on the data storage 220.

The data storage 220 can store information representing web pages that have been crawled and/or accessed by clients 110a, 110b, 110c, . . . 110x. For instance, the data storage 220 can include hyperlinks associated with web pages. The data storage 220 can also include data obtained through a web page crawl (e.g., data embedded in web pages), including web page content associated with one or more web pages. This content can include one or more search result display objects from each web page that identify one or more text or graphic objects to be used in the display of search results. Additionally, data can include one or more default templates (or references to template files) and/or user-defined templates that are used to render search results.

The data storage 220 can also store information indicating a total number of times each of the web pages corresponding to the hyperlinks have been accessed by clients 110a, 110b, 110c, . . . 110x and/or an amount of time (e.g., average time) a client 110a, 110b, 110c, . . . 110x has remained on a web page. The data storage 220 can further include information representing the number of links (e.g., from various other web pages) that point to each particular web page identified in data storage 220.

Alternatively, or in addition to the information described above, the data storage 220 can be used to store information indicating whether a typical client 110a, 110b, 110c, . . . 110x scrolled through the web pages identified in the data storage 220 or linked out of the web pages without scrolling. The data storage 220 can also include user preference data or default preference data that is not associated with access of one or more particular web pages. For instance, the data storage can store user preferences, such as a list or ranking of favorite web sites.

In other alternatives or in addition to the information described above, the data storage 220 can store information identifying the likelihood that a typical client 110a, 110b, 110c, . . . 110x will complete a predetermined action, such as make a purchase associated with an item displayed on a web page, fill out a survey, click on a link, stay on a page for a period of time, or the like. The likelihood that a client will complete a predetermined action, such as make a purchase, can be provided by an entity (e.g., a company or service provider) associated with a particular web page or can be provided from user logs.

The processing component 230 can generate a quality factor for each web page identified by the data storage 220. In some implementations, the quality factor is based on the number of times each web page has been visited by clients 110a, 110b, 110c, . . . 110x, as recorded by the data storage 220. This information can help identify web pages that are most likely to contain valuable information to the users of clients 110a, 110b, 110c, . . . 110x. The processing component 230 can also or alternatively generate the quality factor based on any other information or combination of information logged by the data storage 220. In some implementations, the processing component 230 can store the quality factors for each web page, and optionally store ranked lists of web pages based on quality factors in the data storage 220 or in another storage device.

Although a single data storage 220 is shown in FIG. 2, the data described herein may be stored in a larger number of storage devices internal or external to the storage system 125 and search engine host 120. For instance, data obtained through a crawl of web sites, including search result display object, templates, and the like, could be stored external to the storage system 125 and/or search engine host 120, or may be distributed among many different storage devices.

FIG. 3 is a functional block diagram illustrating an example search engine server 135 in a search system. The search engine server 135 can include a search engine 310 and a display component 320. The search engine 310 can receive a search query from a client 110a, 110b, 110c, . . . 110x and can generate search results that identify relevant documents based on the search query. In some implementations, each search result is assigned a relevancy score by the search engine 310. The relevancy score may be based in part on the information stored in the data storage 220. The relevancy score may also be based in part on the quality factor generated by the processing component 220 for each web page.

The display component 320 receives the search results from search engine 310 and analyzes the relevancy scores to determine how each search result on the results page is displayed to the client 110a, 110b, 110c, . . . 110x that submitted the original search query. The search results can be displayed in order of highest relevancy score to lowest relevancy score. The relevancy score for each search result can be used by the display component 320 to determine how a search result is to be presented, e.g., increasing the size of the font for the search result in displaying multiple search results. In some implementations, relevancy scores range from 0 to 1.0 and represent a probability that a user will select a particular search result. A relevancy score of 1.0 can represent that a user is expected to select the search result (i.e., a 100% probability of selection), and a relevancy score of 0 can represent that a user is not expected to select the search result (i.e., a 0% probability of selection). Other relevancy measurements and/or ranges can be used to effect the results disclosed herein.

The display component 320 is also operable to display the results using data stored by the storage system 125. In particular, the display component 320 uses search result display objects associated with a web page to display the search result for that web page, where each search result display object specifies one or more text, graphic, video, and/or audio objects to be displayed in the search result. The display component 320 uses default or user-defined templates to render one or more of the objects identified by each search result display object. More particularly, the templates determine if the one or more objects are displayed in the search result, the display location of the objects in the search result, or both.

Using search result display objects and templates, the display component 320 can display a search result with custom text effects, such as bolding, underlining, italicizing, or capitalizing a search result. Almost any other text effect can be implemented, including modification of the font color used to display a search result. Furthermore, any part of a search result can be presented in one or more of the manners described above, such as the title, a snippet, and/or URL.

In some implementations, the display component 320 can display one or more videos, images, and/or audios for a search result; a portion of the website; a ‘favicon’; or other content calling the user's attention to the search result. In some implementations, the display component 320 can animate a search result, such as causing one or more parts of a search result to actively move on the search results page.

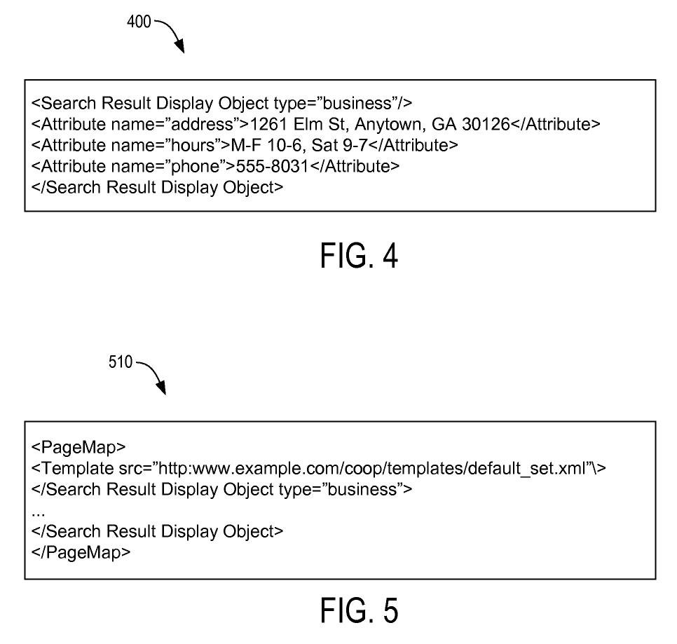

FIG. 4 shows an example search result display object 400 that includes sets of key-value pairs. The example search result display object 400 can be included within a web page and includes information that the webmaster or the creator or owner of the web page may wish to present in a search result, e.g., to a user query submitted to an Internet search engine. During a crawling process, the search result display object is identified and stored in the storage system 125. In some implementations, search result display objects are identified by HTML or similar code using a name, such as the name “Search Result Display Object.” Thereafter, when the web page is identified as a pertinent result, the search engine server 135 is operable to find the search result display object and provide the search result display object to the display component 320 to display a search result including content (e.g., text, graphics, audio, or video) included within or identified by the search result display object.

The search result display object shown in FIG. 4 includes three attributes, “address”, “hours”, and “phone”, which correspond to keys in key-value pairs. The corresponding address, “1261 Elm St, Anytown, Ga. 30126”, hours, “M-F 10-6, Sat 9-7”, and phone number “555-8031” are the values in the key-value pairs. The search result display object is identified by HTML code, and in this example, the code <Search Result Display Object type=“business”/> identifies the beginning of the search result display object 400 and the code </Search Result Display Object> identifies the end of the search result display object 400. The attributes defined by the search result display object are each identified by a respective attribute name. In the example search result display object 400 the attribute names are “address”, “hours”, and “phone”.

Each of the key-value pairs can be stored by the storage system 125 and retrieved for display during rendering of a search results page, for instance, by the display component 320. Thus, each of the values may be displayed on a search results page. As an example, a search result for a web page having the example search result display object 400 included in it can include the attributes and values, which are defined for that web page using, e.g., HTTP or XML, as described above.

Using a search result display object such as the example search result display object 400 shown in FIG. 4 enables a webmaster, creator or owner to define content that will be displayed to users on a search page. Key-value pairs can include or identify not only text information, but also other type of content, including video, images, audio, and the like. The values in key-value pairs can include the content (e.g., text) or link to the content, which can be retrieved by the display component during creation of a search result. In some implementations, all of the attributes and corresponding data must also occur in the visible content of a web page for it to be used in rendering a search result to help ensure that the search result represents a fair summary of the content of the page.

There may be a single search result display object per web page or multiple search result display objects per web page. For instance, in a web page that includes multiple reviews (e.g., product reviews or movie reviews) per page, there can be multiple search result display objects, with one object corresponding to the content reviewed (e.g., a product search result display object or movie search result display object), and one or more objects corresponding to the reviews. A web site having multiple web pages can also include multiple search result display objects.

Although a search result display object can be embedded in a web page, such as the example search result display object 400 of FIG. 4, search result display objects can also be automatically generated after a web page is crawled. For instance, key-value pairs may be automatically derived from web page content. In particular, crawling software can identify keys and their corresponding values automatically. The crawling software can be executed, for instance, by the host 120. As an example, a page including a ten digit number with the first three enclosed in parenthesis may be identified by software as a telephone number, such that a key value pair is automatically generated. Therefore it is not mandatory that search result display objects be embedded in web pages. For instance, subsequent to the crawling of a web page the search engine host 120 can generate and store search result display objects for web pages based on content contained within the pages. As an example, telephone numbers and addresses on a web page can be automatically identified and stored as values associated with “phone” and “address” keys within a system-generated search result display object.

In some implementations, key-value pairs can be retrieved from one or more data feeds provided, for instance, by a web site. Thus, extractions of information from a web site is not required. As an example, a web site that hosts movie reviews could routinely, e.g., daily or hourly, transmit data including keys and their values to the host 120 for storage in the storage system 125. Therefore, key-value pairs can be extracted from web pages, from meta-data in the web page or a URL for the page, and/or through accessing data feeds provided by a web site.

Additionally, in some implementations, key-value pairs may be identified by web sites as URL predicates, i.e., predicates on the properties of documents. These may be forwarded and/or retrieved by the host 120. Example URL predicates are ‘has_property(url, “rating”, “4 stars”)’ and ‘has_property(url, “cost”, “17.95 USD”)’. Some properties are of the document itself (e.g., document type), and some are of the object the document describes (e.g., a product) or the author/organization producing the document. Predicates may be transferable from related web pages (price on one page, ISBN # on another) or aggregated across an entire domain or URL prefix (single-domain small business sites).

The key-value pairs used to populate a search result are displayed according to a template that is used to render the search result. In some implementations, the template is used by the display component 320 to determine the display location of content, such as attributes and/or values in key-value pairs. In some implementations, the template is used to determine what content is displayed, its position (e.g., location in the search result), and/or its size.

FIG. 5 shows an example template file reference and search result display object 510 contained within a web page. In particular, the template file reference and search result display object 510 shown in FIG. 5 includes a reference to a template file at http://www.example.com/coop/templates/default_set.xml. The template file permits the rendering of a search result based on search result display objects identified on a web page or, as described above, created based on a crawl of a web page. A template file is a file, e.g., an HTML or XML file, that identifies what attributes are displayed and their location and size.

If a template file is not specified in or for a web page, a default predefined set of templates may be used that are tailored to popular content. In some implementations, webmasters can generate their own custom templates. The templates may be written, for instance, in HTML or XML, and can define the location and size of objects placed in a search result listing.

The same web page content (e.g., the same search result display objects) can be rendered differently as search results based on the template used to render the search results. For instance, a local-business listings site might use a template specific for restaurants, which could include a “summary” field from the restaurant itself (“best sushi in Long Beach”), whereas a restaurant review site might use the a template specific for restaurant reviews, which could include a “summary” field providing content from a reviewer. Thus, although much of the content on the web pages is the same (e.g., address, telephone number, hours, etc., of the restaurant), the templates used to render the search results cause the results to appear different to the user that submitted the search query.

In some implementations, a large number of standard templates that are tailored to the contents of typical web pages may be selected by webmasters. For instance, template types can include templates for ‘reference’ web pages (e.g., person, place, thing), ‘statistics’ web pages (e.g., sports players, teams, events), product web pages (e.g., book, auction, album, software), review web pages (e.g., movie, business, products), and the like. In some implementations, templates can be auto-selected by the display component 320 based on the types of objects that are found on the page. A test web page may permit a webmaster to enter the URL of a web page the webmaster wishes to test a template on, after which the host 120 will crawl the web page and render the custom search result using the search result display object and user-defined, default, or automatically selected template.

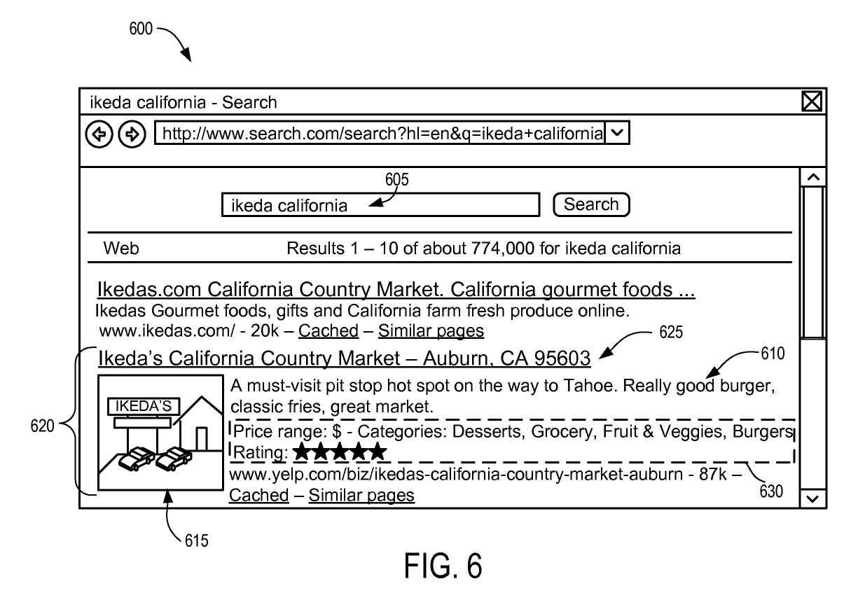

FIG. 6 illustrates an example search results web page 600 for the search query “ikeda california” 605. The second search result 620 is an example search result generated using search result display objects and at least one review template. Similar to conventional search results, the search result 620 includes a title link 625 to a web page, two lines of text 610 (i.e., a ‘snippet’) taken from the web page, and a URL web address of the linked page.

The search result 620 also includes an image 615 and rich content 630 that is based on search result display objects that include key-value pairs. For instance, the webmaster for the web page represented by the search result may have embedded key-value pairs as attributes in the linked page. Attribute keys would include, for instance “price range”, “categories”, “rating”, “address”, “image”, and “telephone number”, with respective corresponding keys, such as “$”, “Desserts, Grocery, Fruits & Veggies, Burgers”, “4.5 stars”, “555 μm Street”, “www.example.com/market.jpg”, and “555-0482”. The web page may also have included a link to a ‘review’ template file for rendering the key-value pairs. Alternatively, the ‘review’ template file may be automatically selected by the display component 320 as a default or based on contents of the page (including, e.g., key-value pairs).

For the example search result 620 shown in FIG. 6, the template includes instructions that the search result include a single line of rich content 630 displaying the search result display objects, in particular, the key-value pairs. The template also includes instructions that only certain key-value pairs be displayed. For instance, the template can indicate that only the “price range”, “categories”, and “rating” keys be displayed along with their corresponding values. Additionally, the template can indicate that the linked image corresponding to the “image” key be sized to fit on the left side of the search result and be resized to a particular height and width.

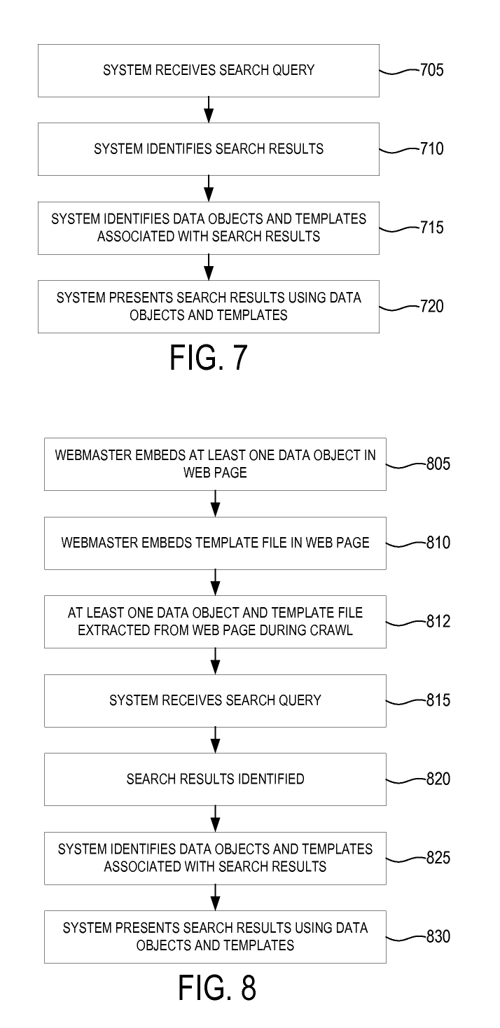

FIG. 7 is a flow diagram for an example method implemented by a search system. A search query is received (step 705). For instance, the search engine host 120 can receive a search query from a client 110. Search results that satisfy the search query are then identified (step 710). This can be performed, for instance, using the search engine host 120 and search engine server 135. At least one search result display object and at least one template associated with a search result are also identified (step 715). For instance, one or more search result display objects and templates may be retrieved from the storage system 125. Thereafter, the search results are displayed with content included in the one or more search result display objects, where the content is rendered according to a template (step 720).

FIG. 8 is a flow diagram illustrating a method as performed by a webmaster (or other person with the ability to change the content of a web page) and a search system. At least one search result display object is inserted into a web page (step 805). For instance, a webmaster may embed the search result display object in the web page during creation of the web page. A template or reference to a template file is also inserted in the web page (step 810), for instance, by the webmaster. During a crawl of the web page the at least one search result display object and template (or template file) are identified (step 812). For instance, the search engine host 120 can extract the at least one search result display object and the template during a crawl of the web page. Thereafter, a search query is received (step 815). For instance, the search engine host 120 can receive a search query from a client 110. Search results are then identified using the search query (step 820). This can be performed, for instance, using the search engine host 120 and search engine server 135. The at least one search result display object and template (or template file reference) embedded in the web page are identified block (step 825). For instance, where a template file is referenced, the one or more search result display objects and template corresponding to the template file are retrieved from the storage system 125. Thereafter, the search results are displayed with content included in the one or more search result display objects, where the content is rendered according to the template identified by the template file (step 830).

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including, by way of example, a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well, for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method, comprising:
identifying, from a web page:
a search result display object, the search result display object specifying content available for display in a search result, and
a template that renders at least some of the content in the search result; and
presenting the search result responsive to a search query received from a user, wherein the search result is associated with the web page containing the search result display object and template.

2. The method of claim 1, further comprising retrieving the search result display object from the web page or from a data feed.

3. The method of claim 1, wherein identifying the template comprises identifying a template file.

4. The method of claim 1, further comprising using the template to identify the at least some of the content.

5. The method of claim 1, further comprising using the template to determine the display location of the at least some of the content in the search result.

6. The method of claim 1, further comprising retrieving the template from the web page.

7. The method of claim 1, further comprising selecting the template from one or more default templates based on text in the web page.

8. The method of claim 7, further comprising presenting one or more webmaster-selectable default templates to a webmaster associated with the web page.

9. The method of claim 1, further comprising crawling the web page to identify the search result display object, prior to receiving the search query from the user.

10. The method of claim 1, further comprising creating a search result display object based on information retrieved from the web page during a crawling of the web page.

11. The method of claim 1, further comprising displaying a second search result, where the second search result is displayed in a different format than the search result.

12. The method of claim 1, wherein the content comprises images, video, or audio.

13. The method of claim 1, wherein the search result display object comprises key-value pairs.

14. A system, comprising:
one or more computers programmed to perform operations comprising:
identifying, from a web page:
a search result display object, the search result display object specifying content available for display in a search result; and
a template that renders at least some of the content in the search result; and
presenting the search result responsive to a search query received from a user, wherein the search result is associated with the web page containing the search result display object and template.

15. The system of claim 14, wherein the one or more computers are further programmed to perform operations comprising retrieving the search result display object from the web page or from a data feed.

16. The method of claim 14, wherein identifying the template comprises identifying a template file.

17. The system of claim 14, wherein the one or more computers are further programmed to perform operations comprising using the template to identify the at least some of the content.

18. The system of claim 14, wherein the one or more computers are further programmed to perform operations comprising using the template to determine the display location of the at least some of the content in the search result.

19. The system of claim 14, wherein the one or more computers are further programmed to perform operations comprising retrieving the template from the web page.

20. The system of claim 14, wherein the one or more computers are further programmed to perform operations comprising selecting the template from one or more default templates based on text in the web page.

21. The system of claim 20, wherein the one or more computers are further programmed to perform operations comprising presenting one or more webmaster-selectable default templates to a webmaster associated with the web page.

22. The system of claim 14, wherein the one or more computers are further programmed to perform operations comprising crawling the web page to identify the search result display object, prior to receiving the search query from the user.

23. The system of claim 14, wherein the one or more computers are further programmed to perform operations comprising creating a search result display object based on information retrieved from the web page during a crawling of the web page.

24. The system of claim 14, wherein the one or more computers are further programmed to perform operations comprising displaying a second search result, where the second search result is displayed in a different format than the search result.

25. The system of claim 14, wherein the content comprises images, video, or audio.

26. The system of claim 14, wherein the search result display object comprises key-value pairs.
